(19) United States
(12) Patent Application Publication
(10) Pub. No.: US 2009/0204275 A1
(43) Pub. Date: Aug. 13, 2009

(54) Electronic control unit

(76) Inventor: Thilo Jahn, Ludwigsburg (DE)

Correspondence Address: KENYON & KENYON LLP, ONE BROADWAY, NEW YORK, NY, 10004, US

(21) Appl. No.: 11/921,626

(22) PCT Filed: May 23, 2006
(86) PCT No.: PCT/EP2006/062539

§ 371 Date: Feb. 11, 2009

(30) Foreign Application Priority Data
Jun. 6, 2005 (DE) 10-2005-025-880.8

(51) Int. Cl. G07C 5/08

(52) U.S. Cl. 701/1

(57) ABSTRACT

An electronic control unit for controlling at least one function of a vehicle, having at least one input for receiving control-relevant data from at least one sensor, a computer device for processing the control-relevant data and generating control instructions, and at least one output for outputting the control instructions to at least one actuator, and furthermore having a device for limiting the operation of the control unit in time and/or functionality.

### FIELD OF THE INVENTION

The present invention relates to an electronic control unit.

### BACKGROUND INFORMATION

There are electronic control units for motor vehicles; for example, DE 197 00 353 discusses a device and a method for diagnosis, control, transmission, and storage of safety-relevant system state variables of a motor vehicle. The detection of dynamic operating data of a motor vehicle for recognizing and evaluating situations critical with regard to safety is described therein.

There are control units for the most diverse functions of motor vehicles. For example, typical ABS control units have microcontrollers which are responsible for signal processing, running a controller program, and self-monitoring of the ABS system. Integrating the control and/or monitoring of a plurality of motor vehicle functions in a control unit is also known.

European document no. EP 1 169 686 B1 discusses a device for storing data in a memory of a vehicle, the data being transmitted via a data bus in the vehicle, to which components such as vehicle systems, sensors, actuators and other vehicle components are connected and connectable, the memory being designed as a central memory medium for the components connected to the data bus and is also connected to the data bus in the vehicle, the data being permanently stored in the memory medium over the entire service life of the vehicle.

This device is characterized in that the data are subject to interpretation in different ways via an analyzing arrangement connectable to the memory medium, the data being interpreted in such a way that a measure for use or wear and tear of the vehicle is represented.

During the development of electronic control units by a control unit manufacturer, in practice cooperation with the particular customer, i.e., usually with a vehicle manufacturer, begins early on. In this phase it is possible, for example, to deliver prototypes of control units, which do not meet the guidelines for general use, for limited use to customers. Such delivery of prototypes is tied to the particular customer observing agreements, which, however, cannot be effectively monitored by the prototype's manufacturer. Non-observance of such agreements may also be associated with safety risks.

### SUMMARY OF THE INVENTION

An object of the exemplary embodiments and/or the exemplary embodiments of the present invention is therefore to improve the monitorability of control units, in particular of control unit prototypes.

This object is achieved by an electronic control unit having the features described herein.

The control unit according to the present invention is characterized in that its operation may be limited in time and/or function in a simple manner. Unauthorized operation of the control unit, for example, after a contractually established time period, may thus be effectively prevented by the manufacturer. The control unit according to the present invention is highly advantageous also from the safety point of view. In particular, the operation of a control unit prototype, which may not yet meet all safety requirements, may be limited in time, for example.

Advantageous embodiments of the control unit according to the present invention are described herein.

It has been found advantageous to provide the control unit with a clock for setting a predefinable operation time for the control unit and/or a fixed point in time when the operation of the control unit may be terminated or limited. Such a clock may be implemented in the form of appropriate hardware or software. A software implementation is provided, for example, by appropriately programming a timer or clock of the computer device of the control unit. Such limitation of the operation time may be fixedly set in the software at the time of delivery of the control unit, a user having no access to this parameter. If a fixedly predefined expiration time is to be set, the use of a real-time clock making it possible to set a fixed date has been found advantageous. Using a real-time clock of this type, the operation of-the control unit may be limited in a simple manner in the hardware. The real-time clock also cooperates with the computer device of the control unit. Advantageously, the user of the control unit also has no access to the real-time clock.

The control unit according to the present invention advantageously has a device for non-volatile storage of an already utilized or elapsed operation time of the control unit. If the operation time is to be measured for determining that a presettable total operation time has elapsed (which represents the usual application case), a time value specifying an operation time already utilized may be stored in a read-only memory, for example, an EEPROM or flash memory, during operation. When the system is restarted, this time value (or timer) is reloaded into the system. It should be pointed out that writing to this memory should be allowed even after a supply voltage has been shut off, since otherwise the user would be able to circumvent storage by immediately interrupting the voltage. In this context, regular storage of the time value or timer value, for example every minute, is an option in order to be able to recognize the progress of the operation time already utilized when the system is switched on again with a resolution of at least one minute.

According to another advantageous embodiment of the control unit according to the present invention, the control unit is limited in function by at least partially de-activating a program running on the computer device. For example, if a predefined operation time has elapsed, the system (in the present case an engine controlled by the control unit) may be brought to a safe state with the aid of the software which has or allows only emergency operation features. Further use of the control unit in its original functionality (i.e., in a certain software-hardware combination) is then no longer possible.

It has been found useful to provide a device for ensuring partial functionality of the control unit which enables emergency operation features after the predefined operation time has elapsed and/or after the fixed point in time when the operation of the control unit is to be limited or terminated.

The control unit according to the present invention advantageously has a device for enabling the resumption of operation even after the operation of the control unit has been limited or interrupted. For example, by storing an identification number, it is possible to ensure that the operation may be enabled anew by password in a simple manner. This is advantageous, for example, if extension of the originally estimated operation time is deemed convenient or if a control unit according to the present invention has been proven in practice in such a way that permanent use of the control unit, i.e., without limitation in time or functionality, seems to be justified.

Furthermore, storing an identification or identification number of this type enables an upgrade system of the software running on the computer device to be implemented, in which case a predefinable usage period may be restarted. This is convenient in particular in the software development phase by providing the option of effectively preventing the use of certain test versions for a longer period than foreseen.

By permanently uploading a fully enabled software to the control unit according to the present invention, any limitation may be lifted if so desired.

By comparing the respective identification numbers of different software versions, reverting to an obsolete software version may be effectively prevented if a higher version number of the same software has already been loaded into the control unit. If an already stored identification number (i.e., the identification number of a software already on the control unit) is greater than the identification number of a version of the software currently imported, the system also advantageously goes into a blocking state.

The present invention is explained in detail with reference to the appended drawing and description herein.

### BRIEF DESCRIPTION OF THE DRAWING

FIG. 1 schematically shows an exemplary embodiment of a control unit according to the present invention.

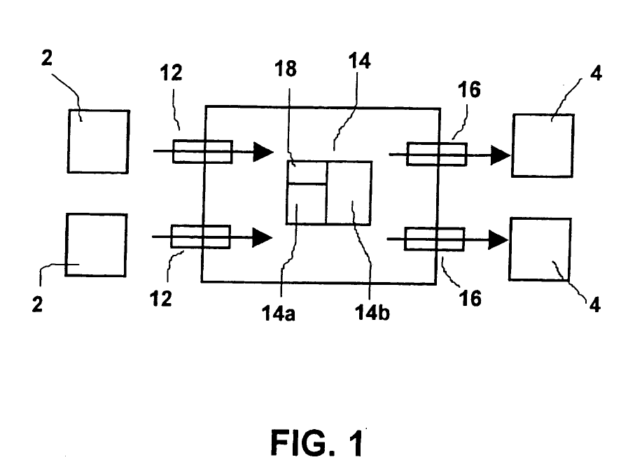

### DETAILED DESCRIPTION

An exemplary embodiment of an electronic control unit according to the present invention (of a motor vehicle which is not illustrated) is labeled overall using reference numeral 10. The control unit has a plurality of (schematically illustrated) inputs 12, which receives control-relevant data from sensors 2 of the motor vehicle. The control-relevant data are uploaded to a computer device 14, which processes the control-relevant data and generates control instructions according to the functionality of control unit 10. The control instructions are supplied to actuators 4 of the motor vehicle via outputs 16.

The computer device has a microprocessor 14a and at least one non-volatile memory area 14b. Further components of the computer device such as, for example, volatile memories, are not illustrated for the sake of simplicity. The computer device advantageously has a timer, in particular a real-time clock (RTC element). A timer of this type is also illustrated schematically and labeled 18. A specific usage time of control unit 10 may be set in advance according to the present invention by appropriately programming computer device 14 or timer 18. A specific maximum operation time may be set, for example, for which control unit 10 is maximally usable. Alternatively or additionally, a time of the day or a date starting from which the operation of the control unit is no longer possible or is possible only to a limited extent may be established with the aid of the real-time clock.

The advantages of the control unit according to the present invention may be summarized as follows:

An operation time already utilized at this point may be regularly stored in non-volatile memory 14b. As elucidated above, unauthorized use of the control unit, in particular circumventing a pre-set specific operation time, may thus be effectively prevented.

With the aid of a software identification system, for example, with the aid of identification numbers, it may be ensured that software versions based on each other are recognized by the system.

Should the set operation time or the real-time clock exceed a fixedly programmed time limit, the system may be set into a safe, but unusable, state.

This safe state may continue to enable emergency functions of the control unit or make the control unit essentially unusable.

Advantageously a memory presence detecting arrangement is provided which recognizes whether or not non-volatile memory 14b is present, i.e., whether it has been removed, for example. If so determined, the system may be set into a safe state.

If the latest identification number stored is higher than the number of a current software, the system may also be set into a safe, in particular unusable, state.

In the case of a software update, an already expired or utilized operation time may be reset in a simple manner.

Finally, by applying one or more enabling codes, the operation time may be extended once or multiple times in a simple manner or any time and/or functional limitation may be lifted.

1-6. (canceled)

7. An electronic control unit for controlling at least one function of a vehicle, comprising:
at least one input for receiving control-relevant data from at least one sensor;
a computer device for processing the control-relevant data and generating control instructions; and
at least one output for outputting the control instructions to at least one actuator having a limiting device for limiting operation of the control unit in at least one of time and functionality.

8. The control unit of claim 7, wherein it has a real-time clock for setting at least one of a predefinable operation time and a fixed point in time when the operation can be limited or terminated.

9. The control unit of claim 8, further comprising: a non-volatile storage device for storing an already elapsed or utilized operation time.

10. The control unit of claim 7, wherein the control unit function can be limited by at least partially de-activating a software program running on the computer device.

11. The control unit of claim 7, wherein the device has an arrangement for ensuring partial functionality of the control unit enabling emergency features after the operation of the control unit has been limited.

12. The control unit of claim 7, wherein the device has an enabling arrangement for enabling resumption of at least one of limited operation and unlimited operation even after the operation has been limited.
